(19) United States
(12) Patent Application Publication
(10) Pub. No.: US 2026/0311523 A1
(43) Pub. Date: Oct. 8, 2026

(54) Method and Apparatus for Adapting a Vehicle Configuration

(71) Applicant: Bayerische Motoren Werke Aktiengesellschaft, Muenchen (DE)

(72) Inventors: Christian Islinger, Muenchen (DE); Florian Eberl, Fraunberg (DE)

(21) Appl. No.: 19/483,114

(22) PCT Filed: Mar. 4, 2024
(86) PCT No.: PCT/EP2024/055583

§ 371 Date: Nov. 10, 2025

(30) Foreign Application Priority Data
May 16, 2023 (DE) 10 2023 112 859.0

(51) Int. Cl. G07C 5/00; G07C 5/08

(52) U.S. Cl. CPC G07C 5/008; G07C 5/006; G07C 5/0808; G07C 5/0816

(57) ABSTRACT

A method is carried out by a control device of a vehicle in order to adapt a vehicle configuration. The method includes determining service data indicative of a service situation of the vehicle. The method also includes setting a configuration parameter of the vehicle based on the service data. The configuration parameter is indicative of a service state of the vehicle.

The present application is the U.S. national phase of PCT Application PCT/EP2024/055583 filed on Mar. 4, 2024, which claims priority of German patent application No. 10 2023 112 859.0 filed on May 16, 2023, the entire contents of which are incorporated herein by reference.

### TECHNICAL FIELD

The present disclosure relates generally to vehicles, and more specifically, to setting a configuration parameter of the vehicle based on service data.

### BACKGROUND

A vehicle that detects a specific state, e. g. a triggering of an airbag, can send a warning message to a backend concerning this state or an event that has caused this state. Necessary measures can be taken as a result, such as e.g. calling a breakdown service. However, this can also have unintended consequences, e.g. an erroneous triggering of a warning message caused by a repair in a workshop. An erroneous triggering of a warning message can be caused by an apparent fault. This can result in customer confusion and annoyance due to unnecessary communication of problems and requirements. This can further be a cause of annoyance for dealers due to unnecessary communication of the need for action.

Automatically transmitted warning messages, for example, which are triggered in a workshop due to a repair or work carried out on the vehicle and are technically incorrect may need to be suppressed. In some cases, the transmitted warning messages have unwanted consequences. The disconnection of an airbag, for example, results in various warning messages, possibly including data transmission. This results in an erroneous triggering of a warning message, for example in a customer app, and can instigate service processes which are unwarranted. This can include, for example, an active call to the breakdown service.

In order to avoid this erroneous triggering of a warning message caused by apparent faults, i.e., for example, to suppress a transmission of a warning message, a physical customer key read-out can be performed in a process step for an order creation. A data point which can be used to filter erroneous triggers in the backend can be generated as a result. However, the customer key read-out can be dependent on a workshop. Not every workshop is configured for a customer key read-out. A physical key is further required for the customer read-out.

A need therefore exists to provide an improved method for adapting a vehicle configuration depending on a service situation.

### SUMMARY

The methods, the device, the computer program and the vehicle according to the independent claims take the above-stated need, as well as others, into account.

Exemplary embodiments are based on the core concept that a method for adapting a vehicle configuration can be carried out on the basis of service data. As a result, for example, a configuration parameter of the vehicle can be set depending on a specific service situation such that an automatic transmission of warning messages is suppressed. A data collection (for example measurement data from an oil sensor) can be suppressed, for example, by software. Due to the suppression of the data collection, the software can no longer detect an event which could result in an apparent fault. A transmission of warning messages can thereby be suppressed, since the software cannot determine a requirement to transmit a warning message.

Exemplary embodiments relate to a method to be carried out by a control device of a vehicle in order to adapt a vehicle configuration. The method comprises determining service data indicative of a service situation of the vehicle, and setting a configuration parameter of the vehicle based on the service data. The configuration parameter is indicative of a service state of the vehicle. A service situation of the vehicle can be determined by determining the service data. A configuration parameter of the vehicle can be set for a specific service situation of the vehicle. The configuration parameter can be set, for example, such that a transmission of a warning message is suppressed. An erroneous triggering of a warning message can thereby be avoided. The user experience can thus be improved.

In one exemplary embodiment, the method can further comprise determining a workshop event and determining the service data based on the workshop event. A workshop event can be an event that takes place in a workshop, for example lifting the vehicle with a lifting platform, resetting a setting for an oil change, detecting a connection of a tester. A service situation for an individual vehicle can be determined by the workshop event. The configuration parameter of the vehicle can thus be set purely on the basis of the service data. A setting of the configuration parameter can thereby be simplified.

In one exemplary embodiment, the method can further comprise obtaining a position of a workshop and obtaining a position of the vehicle. The method can further comprise determining the service data by comparing the position of the vehicle with the position of the workshop. A visit by the vehicle to a workshop can be determined by comparing the position of the vehicle with the position of the workshop. A service situation can thereby be determined on the basis of a local correlation between a vehicle position and a workshop position. The configuration parameter of the vehicle can be set, for example, based on data from other vehicles relating to the position of the workshop.

In one exemplary embodiment, the method can further comprise obtaining the position of the workshop by receiving map data indicative of the position of the workshop. The map data are received from a backend. The updating of the map data can be improved through the reception of the map data from the backend. A determination of service data can thereby be improved.

In one exemplary embodiment, the method can further comprise determining an identity of the workshop and setting a further configuration parameter of the vehicle based on the determined identity of the workshop. The further configuration parameter is indicative of a presence of the vehicle in the workshop. A workshop visit, for example, can be indicated by means of the further configuration parameter. A backend, which communicates with the vehicle, can thereby obtain information relating to the workshop visit in a simplified manner.

In one exemplary embodiment, the method can further comprise transmitting workshop event data indicative of a workshop event of the vehicle. The workshop event data are transmitted to a backend. The control device of the vehicle can inform the backend of relevant workshop events through the transmission of the workshop event data. The backend can create the map data based on the workshop event data. The control device of the vehicle can thereby contribute to the updating of the map data.

Exemplary embodiments relate to a method to be carried out by a backend in order to adapt a vehicle configuration. The method comprises receiving workshop event data indicative of a workshop event of the vehicle. The method further comprises obtaining vehicle position data indicative of a position of the vehicle during an occurrence of the workshop event. The method further comprises creating map data indicative of a position of a workshop based on the workshop event data and the vehicle position data, and transmitting the map data in order to adapt a vehicle configuration. The backend can thereby create map data which can be used by the control device of the vehicle to determine service data.

Exemplary embodiments provide a computer program to carry out one of the methods described herein when the computer program runs on a computer, a processor, or a programmable hardware component.

A further exemplary embodiment is a device for adapting a vehicle configuration. The device comprises an interface for communicating with a backend or a control device of a vehicle, and a data processing circuit which is designed to carry out at least one of the methods described herein. Exemplary embodiments additionally provide a vehicle having a device as described herein.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a schematic representation of a method for adapting a vehicle configuration;

FIG. 2 shows a schematic representation of a further method for adapting a vehicle configuration;

FIG. 3 shows a schematic representation of a method for a system; and

FIG. 4 shows a block diagram of an exemplary embodiment of a device for adapting a vehicle configuration.

### DETAILED DESCRIPTION

Various exemplary embodiments will now be described in more detail with reference to the attached drawings, in which some exemplary embodiments are shown. The thickness measurements of lines, layers and/or regions can be shown in exaggerated form in the figures for the sake clarity.

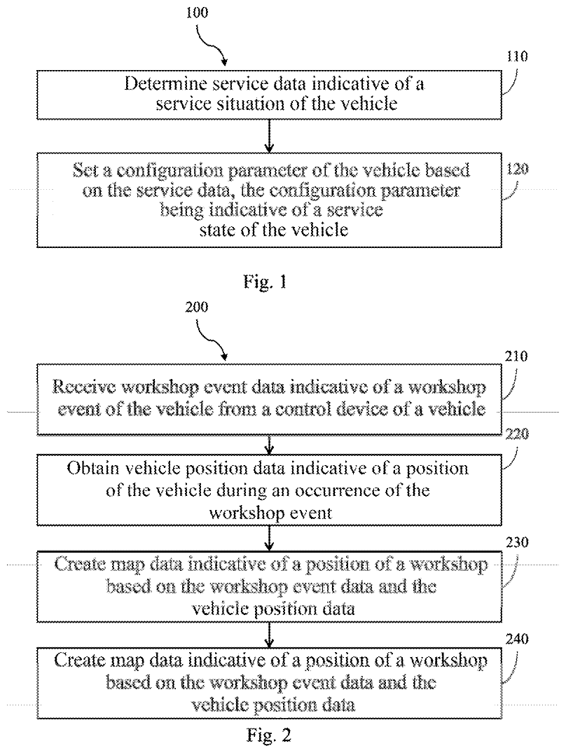

FIG. 1 shows a schematic representation of a method 100 for adapting a vehicle configuration. The method 100 to be carried out by a control device of a vehicle comprises determining 110 service data indicative of a service situation of the vehicle.

A service situation can be a situation in which a service is carried out on the vehicle. A tester, for example, can be connected to the vehicle, for example to an on-board socket. The vehicle can be in a service situation insofar as a tester is connected to the vehicle. The vehicle can be located, for example, on a lifting platform. This state of the vehicle can be recognized by the absence of spring tension on the tires and a vehicle speed of 0 km/h. The vehicle can be in a service situation insofar as a vehicle is located on a lifting platform.

A service situation can be determined during the performance of the service on the vehicle, for example while a tester is connected to the vehicle, or while the vehicle is located on a lifting platform. Optionally or alternatively, a service situation can be determined after the performance of a service. An oil change parameter, for example, indicative of a required oil change can be modified after an il change. The modification of the oil change parameter can be carried out after the performance of the oil change. The service situation can be determined depending on the modification of the oil change parameter. The service situation can thereby be determined following the completion of the service.

information relating to a service situation can therefore be determined by determining the service data. A time period can be determined, for example, in which an apparent fault can occur which can trigger a warning message.

A vehicle which is in a service situation can output an unwanted warning. A critical warning, for example, can be transmitted as data and can trigger an unwanted service process due to apparent faults. This can result, for example, in calls by a breakdown service or an automatically generated email or an app message which can reduce the user experience.

A configuration parameter of the vehicle can be adapted in order to prevent an unnecessary communication due to an apparent fault. The method 100 further comprises setting 120 a configuration parameter of the vehicle based on the service data. A configuration of the vehicle can be modified by setting the configuration parameter such that a transmission of warning messages triggered by an apparent fault can be prevented. A user experience can thereby be improved.

A transmission of a warning message, for example, can be suppressed by setting the configuration parameter of the vehicle. Optionally or alternatively, the configuration parameter of the vehicle can prevent software from performing an action, for example receiving data from a sensor. Generation of an apparent fault can be avoided by preventing the action of the software. A transmission o H a warning message can also be prevented by preventing the generation of the apparent fault.

The configuration parameter is indicative of a service state of the vehicle. A service state of the vehicle can indicate, in particular, that the vehicle state is configured to carry out a service. The vehicle state can therefore be set to a service state by setting 120 the configuration parameter. The transmission of warning message for an apparent fault can thereby be avoided.

A vehicle state that is based on a workshop process, i.e. a service situation, rather than on customer usage can be identified by the method 100. In one exemplary embodiment, the method 100 can further comprise determining a workshop event and determining the service data based on the workshop event. A workshop event can be determined by recognizing vehicle states involving a workshop. A vehicle state involving a workshop, and therefore a workshop event, can be created, for example, by a lifting platform, an occupied on-board socket and/or an activated vehicle mode (for example a programming and diagnosis mode, PAD mode). A vehicle state involving a workshop, and therefore a workshop event, can further be created by a modification of an on-board service configuration, for example the resetting of an oil service.

The service data can be determined based on a specific service situation by determining a workshop event. The reliability of the setting of the configuration parameter of the vehicle can thereby be increased.

The service data can be indicative of a current service situation. This can be the case, for example, for a workshop event as described above. Optionally or alternatively, the service data can be indicative of an increased probability of a service situation. The service situation of the service data can therefore be either a current service situation and/or an increased probability of a service situation.

The vehicle can be located, for example, in a workshop, as a result of which the probability of a service situation can be increased. The configuration parameter of the vehicle can be set on the basis of the increased probability, i.e. the positioning of the vehicle in a workshop area (as described below). A service situation, for example, which is not uniquely identifiable (a unique service situation is, for example, a vehicle on a lifting platform or an occupied on-board socket of the vehicle) can occur in a workshop or workshop area. A service situation which cannot be uniquely correlated with a workshop event, for example a triggering of an airbag due to repair work, can therefore also be taken into account by considering the increased probability.

In one exemplary embodiment, the method 100 can further comprise obtaining a position of a workshop and obtaining a position of the vehicle. The method 100 can further comprise determining the service data by comparing the position of the vehicle with the position of the workshop. The position of the workshop can be obtained by reading out a memory unit. The memory unit can, for example, be part of the control device. Map data can be stored in the memory unit. The map data are indicative of the position of the workshop.

Optionally or alternatively, the position of the workshop can be obtained by receiving map data, for example from a backend. Alternatively, the map data can also be received from a different vehicle.

The position of the vehicle can be obtained by means of a measurement, for example with a GPS sensor. Optionally or alternatively, the position of the vehicle can be obtained by receiving position coordinates. The vehicle can receive the position coordinates, for example, from a wireless local area network module of the workshop.

An increased probability of a service situation can be determined by comparing the position of the vehicle with the position of the workshop. The probability of a service situation can be increased insofar as the vehicle is positioned in a workshop area. The service data can be determined based on the increased probability. These service data can then be used to set 120 the configuration parameter of the vehicle. A service situation which is not simply or uniquely identifiable can be taken into account through a precautionary setting of the configuration parameter of the vehicle. An apparent fault for a service situation which is not simply or uniquely identifiable can thereby be avoided.

A monitoring function, for example, provided in the vehicle can detect whether the vehicle is located inside or outside a workshop area geoposition window. The configuration parameter can be set 120 insofar as the vehicle is located within the workshop area geoposition window.

As described above, a time period can be determined for an occurrence of an apparent fault. The configuration parameter of the vehicle can be set based on the time period. The time period can be associated, for example, with the opening hours of the workshop. The configuration parameter of the vehicle can be set, for example, for the opening hours of the workshop based on the service data. The configuration parameter can be reset outside the opening hours of the workshop so that warning messages can be transmitted once more. This ensures that an event outside the opening hours of the workshop is not erroneously classified as an apparent fault, as a result of which a warning message would be suppressed.

In one exemplary embodiment, the method 100 can further comprise obtaining the position of the workshop by receiving map data indicative of the position of the workshop. The map data are received from a backend. The backend can be configured to create the map data. The creation of the map data by the backend is described with reference to FIG. 2. The updating of the map data can be improved through the reception of the map data from the backend. A determination of the service data can thereby be improved.

In one exemplary embodiment, the method 100 can further comprise determining an identity of the workshop, and setting a further configuration parameter of the vehicle based on the determined identity of the workshop. The further configuration parameter is indicative of a presence of the vehicle in the workshop or workshop area. A workshop visit can be indicated, for example, by means of the further configuration parameter. As a result, a backend which communicates with the vehicle can simply obtain information relating to the workshop visit.

The further configuration parameter can be set as soon as the vehicle or the control device determines a correspondence between the position of the workshop and the position of the vehicle. The further configuration parameter can be set, for example, when the vehicle enters a workshop or workshop area. The further configuration parameter can be reset when the vehicle leaves a workshop or workshop area.

In one exemplary embodiment, the method 100 can further comprise transmitting workshop event data indicative of a workshop event of the vehicle. The workshop event data are transmitted to a backend. The control device can inform the backend of relevant workshop events by transmitting the workshop event data.

A function or logic, for example, provided in the vehicle can recognize vehicle states or workshop events which provide a technical indication of a workshop visit. These can be, for example, workshop events such as a check control message, a control lamp for an open engine hood and/or a connected tester in the on-board socket. The workshop event data can comprise the GPS position of the vehicle and information relating to the determination of the workshop event. The workshop event data can optionally comprise a unique vehicle identifier. The map data can thereby be adapted to a vehicle type. The creation of map data, for example map data specific to a vehicle type, is described in detail below with reference to FIG. 2.

The control device can generally be a device that is capable of wireless communication. The control device can communicate in a mobile communication system with a backend, e.g. a base station. The control device can communicate, for example, in/via a mobile communication system. The mobile communication system can comprise a multiplicity of transmit points and/or base stations which are capable of transmitting radio signals with the communication device.

Further details and aspects are mentioned in connection with the exemplary embodiments described below. The exemplary embodiment shown in FIG. 1 can comprise one or more optional additional features which correspond to one or more aspects that have been mentioned in connection with the proposed concept or one or more exemplary embodiments described below (e.g. FIG. 2-4).

FIG. 2 shows a schematic representation of a method 200 for adapting a vehicle configuration. The method 200 to be carried out by a backend comprises receiving 210 workshop event data indicative of a workshop event of the vehicle. The backend, which carries out the method 200, can be a counterpart to the control device which has been described with reference to FIG. 1. The workshop event data can be received 120, for example, from a control device of a vehicle, a base station and/or a wireless local area network router.

The method 200 further comprises obtaining 220 vehicle position data indicative of a position of the vehicle during an occurrence of the workshop event. The vehicle position data can be received from the control device of the vehicle and/or a base station. The vehicle position data can be received, for example, in a signal comprising the vehicle position data and the workshop event data. Alternatively, the vehicle position data can be determined by determining the angle of incidence of the signal comprising the workshop event data, or through circulation.

The method 200 further comprises creating 230 map data indicative of a position of a workshop based on the workshop event data and the vehicle position data. The backend can, for example, input data into a GPS database or a map with a point cloud. For this purpose, an area can be defined as a workshop area if a defined point density (number of points of different vehicles in relation to this area) is exceeded. The point density distribution can be defined such that small workshops and hobby garages are ignored.

The backend can thereby create a workshop area database. This workshop area database can contain map data. In order to keep the map data up-to-date, data points, i.e. workshop events that have been transmitted by a vehicle can be automatically deleted on a time basis. A workshop area from which no workshop event has been received for a lengthy period can thus be deleted.

The workshop event data comprise, for example, the workshop event, i.e. a reason for the service situation, GPS coordinates of the vehicle and/or a time of the service situation. The workshop event data can further comprise values of a plurality of selected workshop events and/or values of a plurality of selected trigger mechanisms for determining workshop events. The workshop event data can further comprise a unique, in particular anonymous, vehicle identifier. A unique vehicle distinction can be made based on the vehicle identifier. Distortions caused by frequent workshop events from a small number vehicles can be filtered out as a result.

The method 200 further comprises transmitting 240 the map data in order to adapt a vehicle configuration. The map data can be transmitted 240, for example, to a base station and/or to a control device of the vehicle or of a further vehicle.

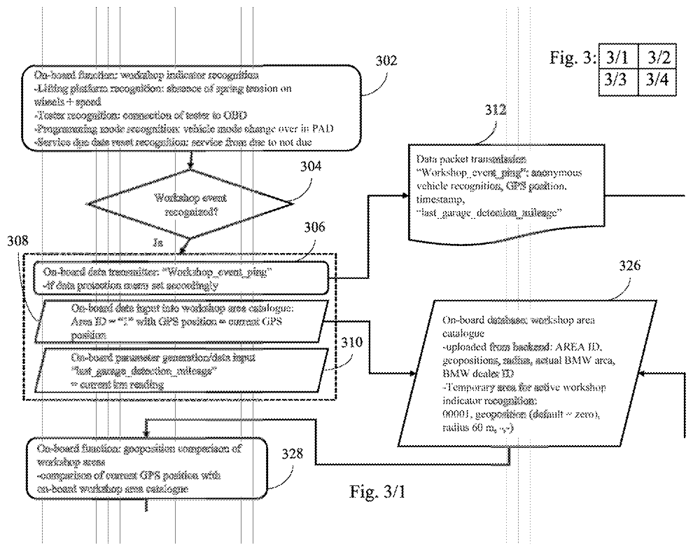

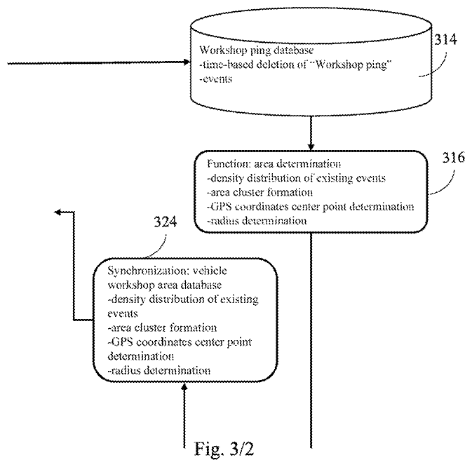

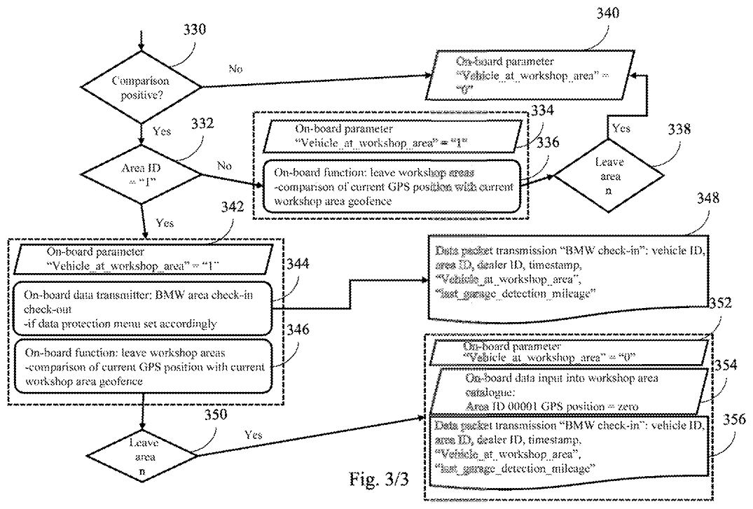

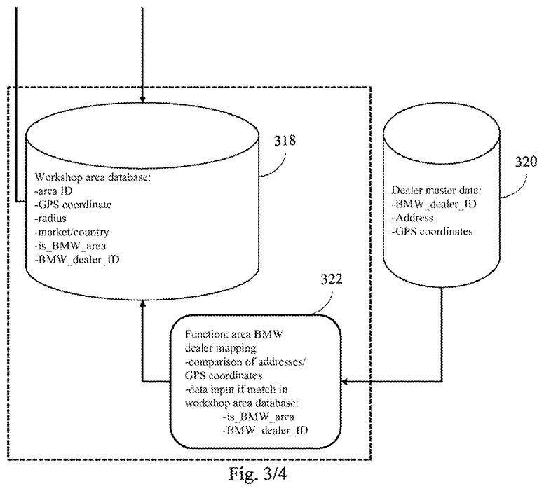

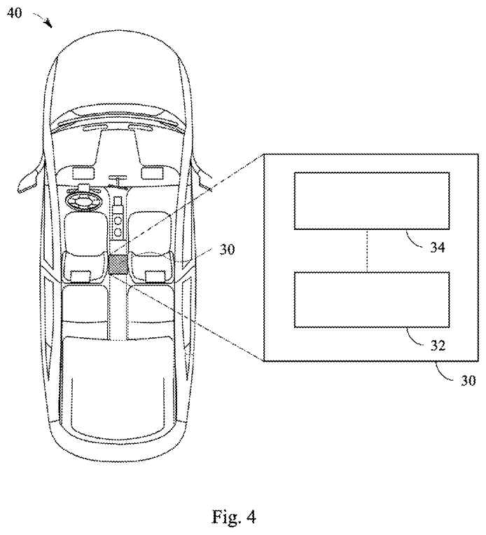

Further details and aspects are mentioned in connection with the exemplary embodiments described above and/or below. The exemplary embodiment shown in FIG. 2 can comprise one or more optional additional features which correspond to one or more aspects that have been mentioned in connection with the proposed concept or one or more exemplary embodiments described above (e.g. FIG. 1) and/or below (e.g. FIG. 3-4).

FIG. 3 shows a schematic representation of a method for a system. In 302, a workshop indicator recognition can be carried out. A workshop event can be determined by means of the workshop indicator recognition. A service situation can thereby be determined.

In 304, a check can be carried out to determine whether a workshop event has been recognized. If the workshop event has been recognized, a transmission of workshop event data can be prepared in 306, for example by creating the workshop event data. Optionally or alternatively, service data can be determined in 308 by comparing the position of the vehicle with the position of the workshop. Map data can be read from a memory unit of the control device of the vehicle or a general control device for this purpose. Optionally or alternatively, a workshop configuration parameter of the vehicle can be set in 310.

A data packet can be transmitted in 312. The data packet can comprise the workshop event data created in 306. In 314, a time-based deletion of received workshop event data can be carried out in the backend. Outdated data can thereby be deleted for the creation of map data. In 316, the map data can be created by the backend. The map data can comprise a density distribution of existing workshop events, a workshop area geoposition window, GPS coordinates of a center point determination and/or radius determination, i.e. a size of the workshop area geoposition window.

In 318, the map data can be supplemented with further information. In 320, for example, information relating to workshop IDs with associated positions can be obtained from a further backend, for example a backend of an original equipment manufacturer. In 322, the workshop IDs with positions can be assigned to the map data. Workshops, i.e., for example, workshop area geoposition windows, can thereby be provided with a workshop ID in the map data. This can, in particular, enable the setting of a further configuration parameter, as described above.

In 324, the created map data can be synchronized between the backend and the vehicle. To do this, the backend can transmit the map data to the control device H the vehicle. In 326, the control device stores the map data. An on-board database can thereby be created. This on-board database can be used, for example, for a subsequent determination of service data.

In 328, the current vehicle position can be compared with the on-board database, i.e. the position of the workshop which is contained in the on-board database. In 330, a check can be carried out to determine whether a comparison is positive, wherein the vehicle is located at the position of a workshop or in a workshop area. If no correspondence was detected in 330, the configuration parameter can remain unchanged in 340.

If a correspondence was detected in 330, a workshop ID can be checked in 332. If no workshop ID is known, the configuration parameter can be set in 334. A check can further be carried out in 336 to determine whether the vehicle has left the workshop or workshop area once more. In 338, it can be determined whether the vehicle has left the workshop or workshop area. If the vehicle has left the workshop or workshop area, the configuration parameter can be reset in 340.

If no correspondence was detected in 332, the configuration parameter can be set in 342. Moreover, the further configuration parameter can be set in 344. A check-in of the vehicle in the workshop or workshop area can be indicated through the setting of the further configuration parameter. In 348, a data packet relating to the check-in can be transmitted.

A check can further be carried out in 346 to determine whether the vehicle has left the workshop or workshop area once more. In 350, it can be determined whether the vehicle has left the workshop or workshop area. If the vehicle has left the workshop or workshop area, the configuration parameter can be reset in 352. In 354, data can be input into the workshop area. In 356, a data packet relating to the check-out, i.e. a departure from the workshop or workshop area, can be transmitted.

An example of the method illustrated in FIG. 3 is as follows:
a Change Data Capture script can monitor a SomeIP signal “cclist” for defined Critical Condition Monitoring IDs such as “Engine Hood Open”. States of the on-board socket or further states in the vehicle indicating a workshop visit or work on the vehicle can further be detected. The script can comprise a data packet with an ID for distinguishing different vehicles, a rough time stamp, an exact GPS coordinate, the reason for the trigger (e.g.: Critical Condition Monitoring Engine Hood Open) and/or the state of the other workshop-indicating variables (on-board socket state).

A workshop can prepare and process a number x of vehicles during the course of, for example, one month. A quantity <=x of corresponding workshop event data can be transmitted here, in each case with essentially the same or very similar GPS coordinates.

These data packets can be processed in a database in the backend. The individual datasets can be subject to an automatic time-based deletion (e.g.; 8 weeks). If a large number of workshop events are detected, for example if 30 different vehicles transmit within 4 weeks from a GPS coordinate which is identical to within 3 decimal places (~110 meter accuracy), the GPS coordinates can be stored as a workshop area with ID.

A service can upload or transmit country-specific coordinates to country-specific vehicles. A function can regularly check whether the vehicle is located at such an address, i.e. a workshop area. If so, this information can be provided via an on-board electrical system signal (message/variable) with the designation “AtWorkshopArea” =“true” for functions and/or services. If the vehicle is not within the coordinate, the signal can be set to “AtWorkshopArea”=“false”.

A further function can transmit a data packet to the backend if this state changes, with the vehicle ID, the time, the work shop area ID and the current value of the “AtWorkshopArea” signal. This can then be used similar to a physical key read-out as a process point for various service processes.

Further details and aspects are mentioned in connection with the exemplary embodiments described above and/or below. The exemplary embodiment shown in FIG. 3 can comprise one or more optional additional features corresponding to one or more aspects that have been mentioned in connection with the proposed concept or one or more exemplary embodiments described above (e.g. FIG. 1-2) and/or below (e.g. FIG. 4).

FIG. 4 shows a block diagram of an exemplary embodiment of a device 30 for adapting a vehicle configuration. The device can be either a control device of the vehicle (see FIG. 1) or a backend (see FIG. 2). The device 30 comprises an interface 32 for communicating with a backend (for example the backend as described with reference to FIG. 2), or a control device (for example a control device as described with reference to FIG. 1). The device 30 further comprises a data processing circuit 34, which is designed to carry out at least one of the methods described herein, for example the method which is described with reference to FIG. 1 for the control device of the vehicle, or with reference to FIG. 2 for the backend. Further exemplary embodiments are a vehicle 40 having a device 30.

The interface 32 shown in FIG. 4 can correspond, for example, to one or more inputs and/or to one or more outputs for receiving and/or transmitting information, e.g. in digital bit values, based on a code, within a module, between modules, or between modules of different entities. The interface 32 can be designed, for example, to communicate with other network components via a (radio) network or a local connection network.

In exemplary embodiments, the data processing circuit 34 can correspond to any controller or £ processor or programmable hardware component. The data processing circuit 34 can also be implemented, for example, as software which is programmed for a corresponding hardware component. In this respect, the data processing circuit 34 can be implemented as programmable hardware having correspondingly adapted software. Any processors, such as digital signal processors (DSPs), can be used. Exemplary embodiments are not restricted to a specific type of processor. Any processors or even a plurality of processors are conceivable for implementing the data processing circuit 34.

As shown in FIG. 4, the interface 32 can be coupled to the respective data processing circuit 34 of the device 30. In examples, the device 30 can be implemented by means of one or more processing units, one or more processing devices, any processing means, e.g. a processor, a computer or a programmable hardware component, which can be operated with correspondingly adapted software. Similarly, the described functions of the data processing circuit 34 can also be implemented in software, which is then executed on one or more programmable hardware components. Such hardware components can be a multi-purpose processor, a digital signal processor (DSP), a microcontroller, etc. The data processing circuit 34 can be capable of controlling the interface 32 so that any data transmission takes place via the interface 32, and/or any interaction in which the interface 32 can be involved can be controlled by the data processing circuit 34.

In one embodiment, the device 30 can comprise a memory and at least one data processing circuit 34 which is functionally coupled to the memory and is configured such that it carries out one of the methods described above.

In examples, the interface 32 can correspond to any means for obtaining, receiving, transmitting or providing analog or digital signals or information, e.g. any connection, contact, pin, register, input connection, output connection, conductor, track, etc., which enables the provision or the acquisition of a signal or information. The interface 32 can be wireless or wired, and can be configured such that it can communicate with further internal or external components, e.g. can transmit or receive signals or information.

In at least some exemplary embodiments, the vehicle 40 can correspond, for example, to a land vehicle, a watercraft, an aircraft, a rail vehicle, a road vehicle, an automobile, a bus, a motorcycle, an off-road vehicle, a motor vehicle, or a truck. The device 30 can, for example, be a part of or can be a control unit of the vehicle 40.

Further details and aspects are mentioned in connection with the exemplary embodiments described above. The exemplary embodiment shown in FIG. 4 can comprise one or more optional additional features corresponding to one or more aspects that have been mentioned in connection with the proposed concept or one or more exemplary embodiments described above (e.g. FIG. 1-3).

Further exemplary embodiments are computer programs to carry out one E the methods described herein when the computer program runs on a computer, a processor or a programmable hardware component. Depending on specific implementation requirements, exemplary embodiments can be implemented in hardware or in software. The implementation can be carried out using a digital storage medium, for example a floppy disk, a DVD, a Blu-ray disc, a CD, a ROM, a PROM, an EPROM, an EEPROM Or a FLASH memory, a hard disk or other magnetic or optical storage device on which electronically readable control signals are stored that can interact or interact with a programmable hardware component such that the respective method is carried out.

A programmable hardware component can be formed by a processor, a computer processor (CPU=Central Processing Unit), a graphics processor (GPU=Graphics Processing Unit), a computer, a computer system, an application-specific integrated circuit (ASIC), an integrated circuit (IC), a system-on-chip (SOC), a programmable logic element or a field-programmable gate array (FPGA) having a microprocessor.

The digital storage medium can therefore be machine-readable or computer-readable. Some exemplary embodiments therefore comprise a data carrier which has electronically readable control signals that are capable of interworking with a programmable computer system or a programmable hardware component such that one of the methods described herein is carried out. One exemplary embodiment is therefore a data carrier (or a digital storage medium or a computer-readable medium), on which the program to carry out one of the methods described herein is recorded.

Generally Speaking, Exemplary Embodiments Can Be implemented as a program, firmware, computer program or computer program product having a program code, or as data, wherein the program code or the data is/are effective in carrying out one of the methods when the program runs on a processor or a programmable hardware component. The program code or the data can also be stored, for example, on a machine-readable carrier or data carrier. The program code or the data can be provided, inter alia, as source code, machine code or byte code or other intermediate code.

The exemplary embodiments described above merely represent an illustration of the principles of the present invention. Modifications and variations of the arrangements and details described herein will obviously be evident to other persons skilled in the art. The invention is therefore intended to be restricted only by the protective scope of the following patent claims, and not by the specific details that have been presented herein by means of the description and the explanation of the exemplary embodiments.

### REFERENCE SIGN LIST

30 Device
32 Interface
34 Data processing circuit
40 Vehicle
100 Method to be carried out by a control device in order to adapt a vehicle configuration
110 Determine service data
120 Set a configuration parameter
200 Method to be carried out by a backend in order to adapt a vehicle configuration
210 Receive workshop event data
220 Obtain vehicle position data
230 Create map data
240 Transmit the map data
302 Carry out workshop indicator recognition
304 Check whether workshop event has been recognized
306 Prepare a transmission of workshop event data
308 Determine service data
310 Set a workshop configuration parameter
312 Transmit workshop event data
314 Time-based deletion of workshop event data
316 Create map data
318 Supplement map data
320 Obtain information relating to a workshop ID
322 Assign the workshop to the workshop event data
324 Synchronize created map data
326 Store map data
328 Compare vehicle position and workshop position
330 Check the comparison
322 Check the workshop ID
334 Set configuration parameter
336 Check whether the vehicle has left the workshop
338 Determine that the vehicle has left the workshop
340 Reset configuration parameter
342 Set configuration parameter
344 Set further configuration parameter
346 Check whether vehicle has left workshop
348 Transmit data packet relating to check-in
350 Determine that vehicle has left workshop
352 Reset configuration parameter
354 Input data into the workshop area
356 Transmit data packet relating to check-out

1.-10. (canceled)

11. A method to be carried out by a control device of a vehicle in order to adapt a vehicle configuration, comprising:
determining service data indicative of a service situation of the vehicle, and
setting a configuration parameter of the vehicle based on the service data, said configuration parameter being indicative of a service state of the vehicle.

12. The method as claimed in claim 11, further comprising:
determining a workshop event, and
determining the service data based on the workshop event.

13. The method as claimed in claim 12, further comprising:
transmitting workshop event data indicative of the workshop event of the vehicle to a backend.

14. The method as claimed in claim 12, further comprising:
obtaining a position of a workshop, and
obtaining a position of the vehicle, and
determining the workshop event by comparing the position of the vehicle with the position of the workshop.

15. The method as claimed in claim 11, further comprising:
obtaining a position of a workshop, and
obtaining a position of the vehicle, and
determining the service data by comparing the position of the vehicle with the position of the workshop.

16. The method as claimed in claim 15, further comprising:
obtaining the position of the workshop by receiving map data indicative of the position of the workshop from a backend.

17. The method as claimed in claim 16, further comprising:
determining an identity of the workshop, and
setting a further configuration parameter of the vehicle based on the determined identity of the workshop, said further configuration parameter being indicative of a presence of the vehicle in the workshop.

18. The method as claimed in claim 17, further comprising transmitting a data packet including information relating to the further configuration parameter.

19. The method as claimed in claim 15, further comprising:
determining an identity of the workshop, and
setting a further configuration parameter of the vehicle based on the determined identity of the workshop, said further configuration parameter being indicative of a presence of the vehicle in the workshop.

20. The method as claimed in claim 15, further comprising:
transmitting workshop event data indicative of the workshop event of the vehicle to a backend.

21. The method as claimed in claim 11, further comprising:
transmitting information indicative of the service data of the vehicle to a backend.

22. A non-transitory computer storage medium containing computer instructions that, when run on a computer, a processor, or a programmable hardware component, carry out the method of claim 11.

23. A method to be carried out by a backend in order to adapt a vehicle configuration, comprising:
receiving workshop event data indicative of a workshop event of the vehicle;
obtaining vehicle position data indicative of a position of the vehicle during an occurrence of the workshop event;
creating map data indicative of a position of a workshop based on the workshop event data and the vehicle position data; and
transmitting the map data in order to adapt a vehicle configuration.

24. A non-transitory computer storage medium containing computer instructions that, when run on a computer, a processor, or a programmable hardware component carry out the method of claim 23.

25. A device for adapting a vehicle configuration, comprising:
an interface for communicating with a backend or a control device; and
a data processing circuit which is designed to carry the method as claimed in claim 11.

26. A vehicle having the device as claimed in claim 25.
